(19) United States
(12) Patent Application Publication
(10) Pub. No.: US 2006/0224929 A1
(43) Pub. Date: Oct. 5, 2006

(54) Content generating apparatus and method

(75) Inventors: Masayuki Fukui, Kawasaki (JP); Tatsuro Matsumoto, Kawasaki (JP); Yasuhide Matsumoto, Kawasaki (JP); Satoru Watanabe, Kawasaki (JP); Ai Yano, Kawasaki (JP); Kazuo Sasaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/193,434

(22) Filed: Aug. 1, 2005

(30) Foreign Application Priority Data
Mar. 29, 2005 (JP) 2005-095500

(51) Int. Cl. G06F 11/00

(52) U.S. Cl. 714/47

(57) ABSTRACT

A state management apparatus is disclosed which makes a determination whether or not to provide services based on a plurality of state information. For example, it is determined whether all the family members are going out or not based on state information of each family member. If all the family members are going out, the apparatus further determines whether an air conditioner is turned ON or not. If it is determined “Yes”, the apparatus notifies the air conditioner to switch off the power. As such, the state management apparatus makes determinations for providing various services and controlling based on the state information of a plurality of objects such as people, equipment and the like. As a result, implementation of the service applications can be simplified, and developing efficiency can be increased. In addition, it becomes easy to realize flexible services.

### BACKGROUND OF THE INVENTION

1. Field of the Invention

The present invention relates to a state information notification system for managing, updating and/or notifying state information representing the state of a person or an article.

2. Background Information

State management systems for managing a plurality of state information, and for notifying state information to registered user terminals when the state information is updated and a notification condition is satisfied, have been provided. For example, Japanese Laid-Open Publication No. 9-282210 discloses an exemplary state management system. In this state management system, for example, stock prices are managed by a server as the state information. Clients register notification conditions of the state information so that they can be notified by the server when a specific stock reaches a specific stock price. As a result, the clients can buy/sell stocks at an optimum timing in response to the notification.

A type of state management system, a so-called instant messaging (IM) system, is now spreading on Internet. This system provides a service of managing attendance states of people by a server, and notifying a specific client when a certain person is available. More specifically, a user sets a user list, which is called a “buddy list”. Then, the user is notified of the states of other users whom the user registered to the buddy list, i.e., buddies. The states to be notified may be “online”, “offline”, “attending”, “occupied”, and the like. The user can make appropriate communication by referring to the notified states of the buddies. For example, the user can determine timing to make a phone call with reference to the states of the buddies.

These conventional state management systems set a notification condition and notify update of the state information for each of the state information.

It is expected that states of various objects such as people and articles will be digitized and state information managed by the state management systems will increase in the future. It is also expected that, accordingly, services of providing various information based on changes in a plurality of state information from the state management systems will be developed. For example, a demand for service applications which present a screen display on user terminals or which control equipment based on changes in a plurality of state information is expected. However, the conventional state management systems have problems as described below in providing services based on changes of a plurality of state information.

First, when service applications using the conventional state management systems are attempted to be developed, each of the service applications have to determine the necessity of initiating services based on a plurality of state information received from the state management systems and notification information of the state information. As the number of state information being handled increases, the logics of service applications become complicated and efficiency of development decreases.

Second, even in the case where a plurality of service applications initiate services based on the same determination logic, the service applications have to respectively determine the necessity of initiating services. Thus, as the service applications increase, efficiency of development decreases.

In view of the above-mentioned problems, an object of the present invention is to provide techniques for providing information in a flexible manner based on a plurality of state information.

It is also an object of the present invention to simplify the structures of services applications which provide information based on a plurality of state information.

This invention addresses these objects as well as other objects, which will become apparent to those skilled in the art from this disclosure.

### SUMMARY OF THE INVENTION

According to one aspect of the present invention, there is provided a state management apparatus for managing the states of a plurality of objects, comprising: a state storing unit that associates the plurality of objects with state information for the plurality of objects and stores the same; an updating unit that receives an update request for state information for any object and updates the state information for that object based on the update request; a condition storing unit that stores a composite notification condition based on a plurality of state information; and a determining unit that determines whether a composite notification condition based on the updated state information is satisfied or not in response to the update of the state information by the updating unit.

The objects may be any animate and inanimate objects which may have states such as users, equipment, articles and the like, and are not particularly limited. One object can have a plurality of states. The composite notification condition is a combination of a plurality of state values, and defines a composite state. For example, a combination of conditions that state values of the state “distance from home” of the father, mother, and child are respectively 100 m or more can define a composite state where “all family members are going out”.

For example, when the “distance from home” of the father is updated, it is determined whether or not the composite notification condition describing the composite state that “all family members are going out” is satisfied. When the power of an air conditioner is ON although all the family members are going out, a control program for the air conditioner controls the air conditioner to switch off the power. Similarly, states which are necessary for the services to be provided are determined from a combination of the state values of a plurality of objects. Thus, it becomes possible to provide various and flexible services.

In one embodiment of the present invention, a state management apparatus may further comprises a selection screen generating unit for displaying a part or all of the state information stored in the state storing unit and generating a selection screen which receives selection of a plurality of state information.

The selection screen displays identifiers for specifying the stored states, for example, state names. The selection screen generating unit may display a selection screen on a monitor connected to the state management apparatus, or it may provide a selection screen to another computer terminal connected to the state management apparatus via network.

In one embodiment of the present invention, the selection screen generating unit may generate a selection screen which displays the state information grouped according to the objects.

Since the state information are displayed for each of the objects, selection of state information which forms the composite notification condition can be facilitated.

In one embodiment of the present invention, the selection screen generating unit may generate a selection screen which displays the state information in one or more tree structures for each of the objects.

Since the state information are displayed in one or more tree structures with the objects being the roots, structures of the state information can be easily recognized visually.

In one embodiment of the present invention, a state management apparatus may further comprise: a setting screen generating unit that generates a setting screen which receives one or more settings for a composite notification condition based on a plurality of state information for which the selection is received at the selection screen generating unit, wherein the condition storing unit further stores the composite notification condition received by the setting screen generating unit.

For example, the setting screen receives a way of combining the selected state information. The combining way is described by binding conditions of the state values of the state information by logical multiplication and/or logical addition. The setting screen may also receive settings of the conditions of the state values defined by the state information for each of the selected state information.

The setting screen may be displayed on a monitor connected to the state management apparatus, or may be provided to a computer terminal connected to the state management apparatus via network.

In one embodiment of the present invention, a state management apparatus, further comprising: an overlap determining unit that determines whether or not the composite notification condition received by the setting screen generating unit overlaps with the composite notification condition stored in the condition storing unit, wherein the state storing unit further stores the state information of a composite state defined by the overlapping composite notification conditions, and the condition storing unit stores the composite notification condition received by the setting screen generating unit as the composite notification condition based on the state information of the composite state defined by the overlapping composite notification conditions.

Description will be made with reference to the above example. It is assumed that a composite notification condition that the distances from home of the father, mother, and child are respectively 100 m or more (composite notification condition 1) has already been stored in the condition storing unit. It is also assumed that a new composite conditional condition where composite notification condition 1 is satisfied and the power of the air conditioner is ON is set (composite notification condition 2). Since the composite notification condition 1 is overlapping, the state information of the composite state defined by the composite notification condition 1 is stored in the state storing unit. Composite notification condition 2 is described based on the state information of such a composite state and the state information of the air conditioner.

In this way, the state management apparatus no longer have to repeatedly make determination on the same conditional expression. Thus, a burden on the state management apparatus to determine the composite notification condition is alleviated.

In one embodiment of the present invention, the overlap determining unit may generate a confirmation screen for confirming the result of determination.

When vagueness is allowed in overlap determination for the composite notification conditions, it is preferable that determination result is confirmed on the confirmation screen. This is because, even when the overlap determining means determines that they are substantially the same composite notification conditions, they may be different composite notification conditions for developers of service application.

In one embodiment of the present invention, the state storing unit stores, as a portion of the state information of the composite state, the result of the determination by the determination unit regarding the composite notification condition which defines the composite state.

Whether a composite notification condition is satisfied or not is represented by, for example, “TRUE” or “FALSE”. This equals to the state value of the composite state. By storing/updating this value, the composite state defined by the composite notification condition can be managed similarly as the state information of the individual objects. In other words, even the composite state which changes in accordance with changes in the individual state information can be managed similarly to the state information of the individual objects.

In one embodiment of the present invention, the state storing unit further stores update history of the state information; the composite notification condition is described using logical multiplication and/or logical addition of the conditions for a plurality of state information; the condition storing unit describes the conditions in descending order of probabilities that the conditions which form the composite notification condition are satisfied for logical multiplication, and in ascending order for logical addition based on the update history of the state information.

The determining unit determines whether the conditions are satisfied or not from the first one of the conditions which form the composite notification condition. Thus, a determination process for the composite notification conditions can be performed more rapidly by determining the conditions in ascending order of the possibilities that the conditions are satisfied for logical multiplication, and in descending order for logical addition.

According to another aspect of the present invention, there is provided state management program executed on a computer terminal which manages the states of a plurality of objects, the state management program causing the computer terminal to function as: a state storing unit that associates the objects with state information for the objects and stores the same; an updating unit that receives an update request for state information for any object and updates the state information for that object based on the update request; a condition storing unit that stores a composite notification condition based on a plurality of state information; and a determining unit that determines whether a composite notification condition based on the updated state information is satisfied or not in response to the update of the state information by the updating unit.

The state management program causes the computer terminal to function as the aforementioned state management apparatus, and has similar functions and effects as those noted above.

A computer readable recording medium having such a program recorded thereon is within the scope of the present invention. The computer readable recording medium may be, for example, a flexible disc, hard disc, CD-ROM, MO, DVD, DVD-ROM, DVD-RAM, Blue-ray Disc (BD), semiconductor memory, and the like.

The computer program is not limited to that recorded on the recording medium, but may be transmitted via telecommunication lines, wireless or wire communication line, networks such as Internet, or the like.

According to yet another aspect of the present invention, there is provided computer readable recording medium having recorded thereon a state management program that manages the states of a plurality of objects, the state management program causing a computer to execute the steps of: associating the objects with state information for the objects and storing the same; receiving an update request for state information for any object and updating the state information for that object based on the update request; storing a composite notification condition based on a plurality of state information; and determining whether a composite notification condition based on the updated state information is satisfied or not in response to the update of the state information at the receiving step.

The recording medium is a recording medium having a program recorded thereon which is run by the aforementioned state management apparatus, and has similar functions and effects as those noted above.

According to still another aspect of the present invention, there is provided state management method for managing states of a plurality of objects, comprising the steps of: associating the objects with state information for the objects and storing the same; receiving an update request for state information for any object and updating the state information of that object based on the update request; storing a composite notification condition based on a plurality of state information; and determining whether a composite notification condition based on the updated state information is satisfied or not in response to the update of the state information at the receiving step.

This method is a method executed by the aforementioned state management apparatus, and has similar functions and effects as noted above.

According to the present invention, the state management apparatuses make determination based on a plurality of state information. Thus, service applications can be simplified. In this way, a flexible and complex management of state information becomes possible.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic block diagram of a state management system according to Embodiment 1.

FIG. 2 is a conceptual diagram illustrating state information stored in a state information management table.

FIG. 3 is a conceptual diagram illustrating composite notification conditions stored in a composite notification condition management table.

FIG. 4 is an illustrative diagram showing exemplary selection screens for state information which form composite notification conditions, in which the portion (A) shows a state before a composite state is registered to the state information management table, and the portion (B) shows a state after a composite state is registered to the state information management table.

FIG. 5 is an illustrative diagram showing an exemplary setting screen for a composite notification condition.

FIG. 6 is an illustrative diagram showing an exemplary confirmation screen for confirming overlap determination.

FIG. 7 is a flow diagram showing an exemplary flow of a state management process performed by the state management apparatus.

FIG. 8 is a flow diagram showing an exemplary flow of a process performed by a state update apparatus.

FIG. 9 is a flow diagram showing an exemplary flow of a process performed by a service application terminal.

FIG. 10 is a schematic block diagram of a state management system according to Embodiment 2.

FIG. 11 is a conceptual diagram illustrating a state information history management table in the state management system according to Embodiment 2.

### DETAILED DESCRIPTION OF THE PREFERRED EMBODIMENTS

Overview of the Invention

State management apparatuses in the state management systems according to the present invention make determination on whether or not to carry out services based on a plurality of state information. For example, the state management systems determines whether or not that all the members of the family are going based on state information of each of the family members. Further, when all the family members are going out, the state management systems determine whether the power of an air conditioner is ON or not. If it is determined “YES”, the state management systems notify the air conditioner to switch off the power.

As described above, the state management systems make determinations for providing various services and for controlling based on state information on a plurality of objects such as people and equipment. As a result, implementation of the service applications can be simplified and developing efficiency can be increased. Also, it becomes easy to realize flexible services.

Embodiment 1

Overall Structure

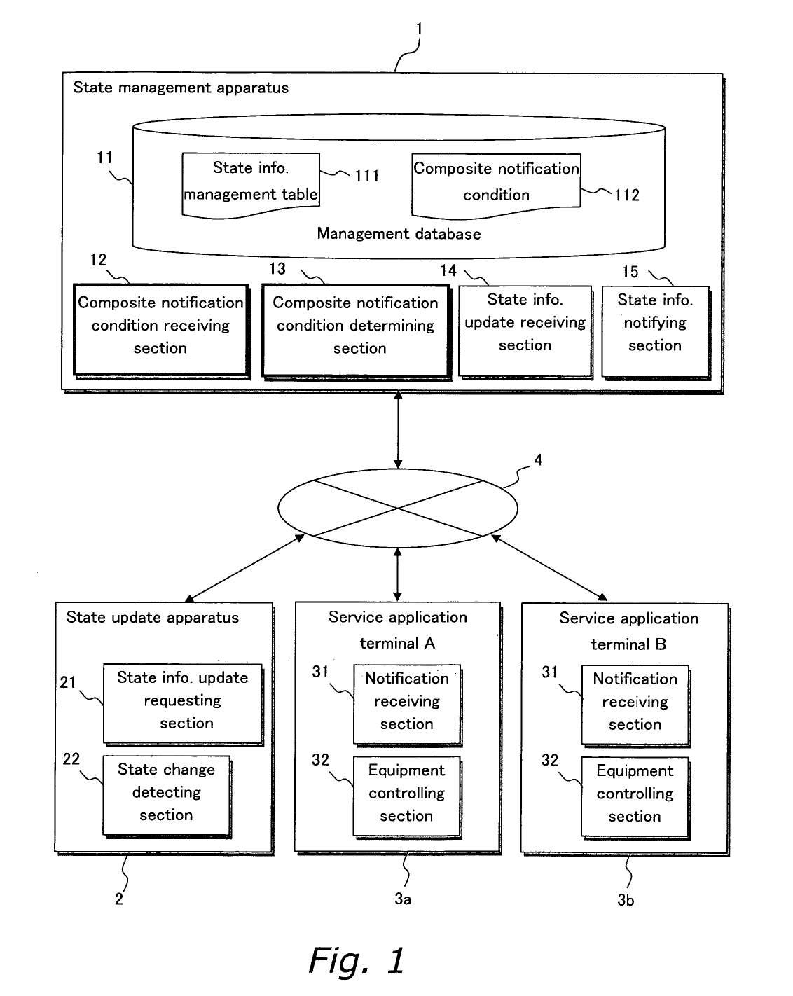

FIG. 1 is a schematic block diagram of a state management system according to Embodiment 1. The state management system is formed of a state management apparatus 1, a state update apparatus 2, and service application terminals 3a and 3b connected by Internet, an intranet, or the like. In FIG. 1, only one state update apparatus 2 is shown, but there may be a plurality of state update apparatuses 2. Similarly, there may be one or more service application terminals 3.

The state management apparatus 1 manages state information and notifies to a predetermined service application terminal 3. The structure and functions of the state management apparatus 1 will be described later in detail.

The state update apparatus 2 includes at least a state change detecting unit 22 and a state information update requesting unit 21. The state change detecting unit 22 detects changes in state information of a user who operates the state update apparatus 2. The state information update requesting unit 21 notifies updated state information to the state management apparatus 1.

The service application terminal 3 is a computer terminal on which service applications run. The service applications may run on microcomputers which control equipment. Each of the service applications includes at least a notification receiving unit 31 and an equipment controlling unit 32. The notification receiving unit 31 receives notifications of predetermined state information from the state management apparatus 1. The equipment controlling unit 32 performs a predetermined process based on the received notification. For example, the equipment controlling unit 32 switches off the power of an air conditioner, or lock an electronic lock of a front door. The processes to be performed by the equipment controlling unit 32 are not specifically limited. They are appropriately designed in accordance with operation environments of the service applications. During development of a service application, the service application terminal 3 may be a computer terminal which is operated by a developer of the service application.

The state management apparatus 1 and the state update apparatus 2 may be on the same computer terminal. Similarly, the state management apparatus 1 and the service application terminal 3 may be on the same computer terminal, and the state update apparatus 2 and the service application terminals 3 may be on the same computer terminal.

State Management Apparatus

(1) Overall Structure

The state management apparatus 1 includes following components (a) through (e).

(a) Management database 11: The management database 11 stores a state information management table 111 and a composite notification condition management table 112. The state information management table 111 manages predetermined objects and state values of the states of the objects. The composite notification condition management table 112 stores conditional expressions representing composite notification conditions (hereinafter, referred to as composite notification conditions). The composite notification conditions are conditional expressions in which conditions for state values of a plurality of states are bound by logical multiplication or logical addition and define composite states. The tables will be described later in detail.

(b) Composite notification condition receiving unit 12: The composite notification condition receiving unit 12 receives selection of objects which form a composite notification condition from the service application terminals 3. The composite notification condition receiving unit 12 also receives settings of composite notifying conditions from the service application terminals 3. Further, the composite notification condition receiving unit 12 makes an entry of a condition which satisfy a composite notification condition (hereinafter, referred to as a composite state) to the state information management table 111, and register objects of the composite state to the state information management table 111.

(c) Composite notification condition determining unit 13: The composite notification condition determining unit 13 determines whether the composite notification conditions stored in the composite notification condition management table 112 are satisfied or not every time a state value of any of the states is updated. The result of determination is represented by either a value “TRUE” or “FALSE”. In other words, the state values of the composite states are represented by “TRUE” or “FALSE”. The state values of the composite states are registered to the state information management table 111 via a state information update receiving unit 14.

(d) State information update receiving unit 14: The state information update receiving unit 14 receives new state values from the state update apparatus 2 and updates the state information management table 111. The state information update receiving unit 14 also receives the state values of the composite states from the composite notification condition determining unit 13, and registers to the state information management table 111.

(e) State information notifying unit 15: The state information notifying unit 15 notifies the state values of the composite states to the service applications.

(2) Management Database

(2-1) State Information Management Table

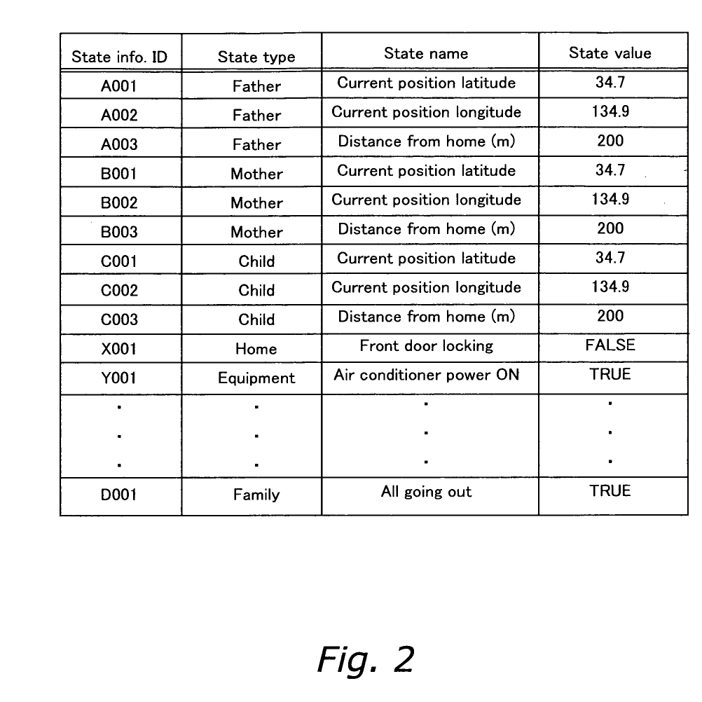

FIG. 2 is a conceptual diagram illustrating the state information stored in the state information management table 111. The state information manages state information of respective objects and state information of the composite states. A composite state is defined by a combination of state values of states determined by composite notification conditions.

In this example, the state information includes a state information ID, a state type, a state name, and a state value in one record. The “state information ID” is an identifier for specifying the state information. The “state type” represents an object of the state information. In this example, the object may be father, mother, child, home, equipment, or the like. The “state name” indicates what the state value means. The “state value” is a value of the state represented by the state name.

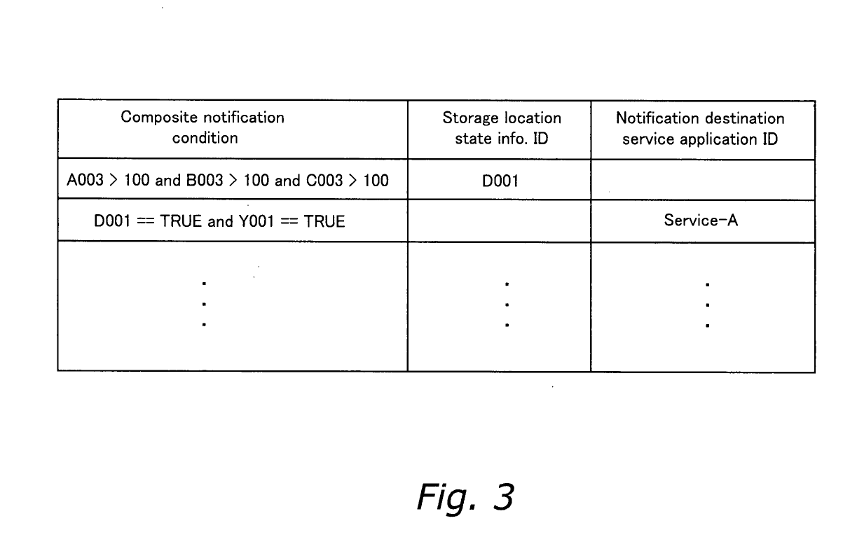

In FIG. 2, a state represented by the state information ID “D001”, state information “family”, state name “all going out”, and state value “FALSE” is a composite state. This composite state is defined by a combination of state values of father, mother, child, and equipment (see FIG. 3 which will be described below).

(2-2) Composite Notification Condition Management Table

FIG. 3 is a conceptual diagram illustrating composite notification conditions stored in the composite notification condition management table 112. In this example, the composite notification condition management table 112 stores a composite notification condition, a storage location state information ID, and a notification destination service application ID in one record.

The “composite notification condition” defines a composite state. The composite notification condition uses the state information ID in the state information management table 111, and describes a combination of a plurality of state information and a condition of the state values. The “storage location state information ID” is an identifier of the composite state defined by the composite notification condition, i.e., a state information ID. The state information IDs are not allocated to all of the composite states. A composite state to which a state information ID is allocated is registered to the state information management table 111. The “notification destination service application ID” defines a notification destination of a composite state. The notification destination service application is described using Uniform Resource Locator (URL), address and/or a port number of network 4, a function name of a program, and the like. The notification destination service application IDs are not necessarily defined for all the composite states.

For example, a composite notification condition “A003>100 and B003>100 and C003>100” shown in FIG. 3 defines a state in which all the father, mother, and child are at a distance of more than 100 m from home. In other words, it defines the state where all the family members are going out. To such a composite state, state information ID “D001” is allocated. Thus, the composite state is registered to the state information management table 111, and changes in the value are managed.

Another composite notification condition “D001=TRUE and Y001=TRUE” shown in FIG. 3 defines a state in which “all the father, mother, and child are at a distance of more than 100 m from home”, and “the power of an air conditioner is ON”. In other words, it defines the state where all the family members are going out, but the air conditioner is ON. Such a composite state is notified to a service application, “Service-A”. The notified service application “Service-A” performs a control operation such as switching OFF the power of the air conditioner.

(3) Functions

Next, functions of the state management apparatus 1 will be described in more detail mainly on the following points: setting of the composite notification conditions; update of the composite states; and management of the state information.

(3-1) Setting of Composite Notification Conditions

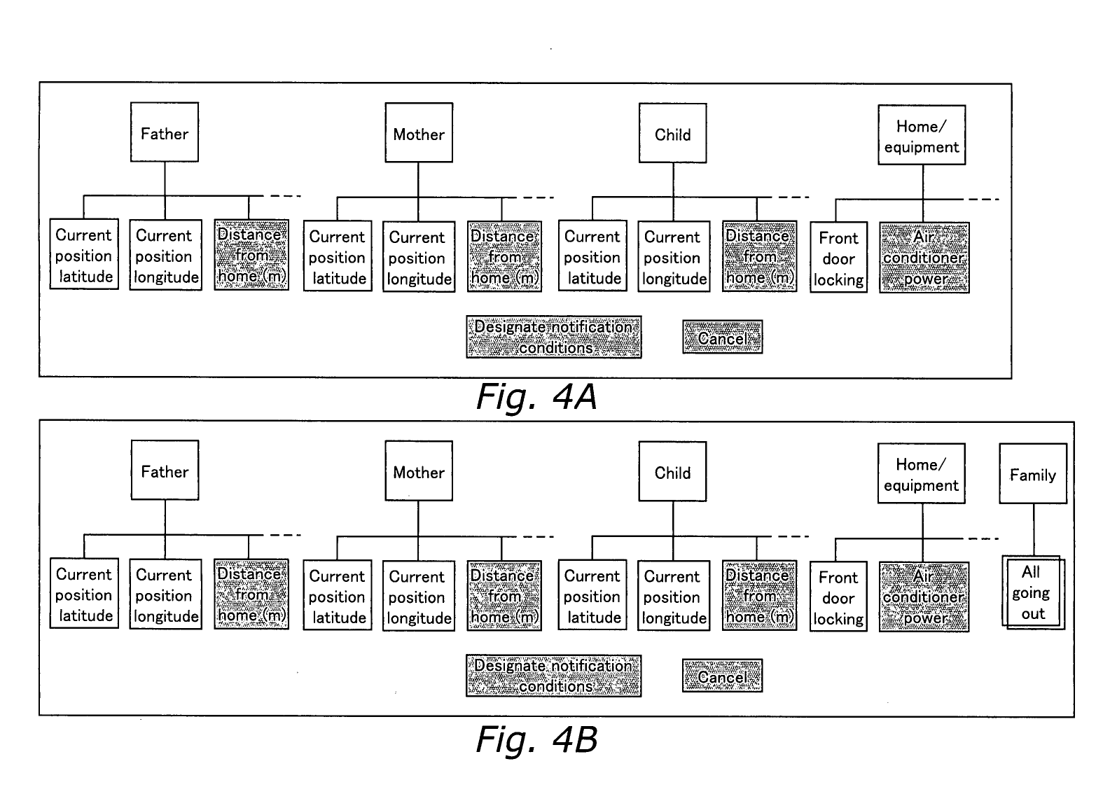

FIG. 4 is an illustrative diagram showing exemplary selection screens for state information which form the composite notification conditions. The composite notification condition receiving unit 12 receives settings of the composite notification conditions from the service application terminals 3. First, the composite notification condition receiving unit 12 provides a selection screen for state information to a service application terminal 3. The selection screen receives selection of a plurality of states which form a composite notification condition. In the portion (A) of FIG. 4, “distance from home (m)” for each of the father, mother, and child, and a state of equipment, “air conditioner power”, are selected.

The portion (B) of FIG. 4 shows a selection screen after a composite state defined by a composite notification condition is registered to the state information management table 111. The selection screen displays a state type of the composite state, “state of family”, and a state name thereof, “all going out”. In other words, by setting a composite notification condition based on state information of a composite state, another composite state can be generated.

Preferably, the composite notification condition receiving unit 12 generates selection screens for displaying state names grouped in according to state types. More specifically, the state information are respectively displayed for every object which is a subject of the state information. For developers of service applications, it is easier to recognize classifications of the stored state information, and to select state information which form the composite notification conditions.

More preferably, the state names are displayed in a tree structure for each of the state type on the selection screens. The state type, i.e., an object which is a subject of the state information is a root in the tree structure of the state names. Thus, the structure of the state information can be easily recognized visually.

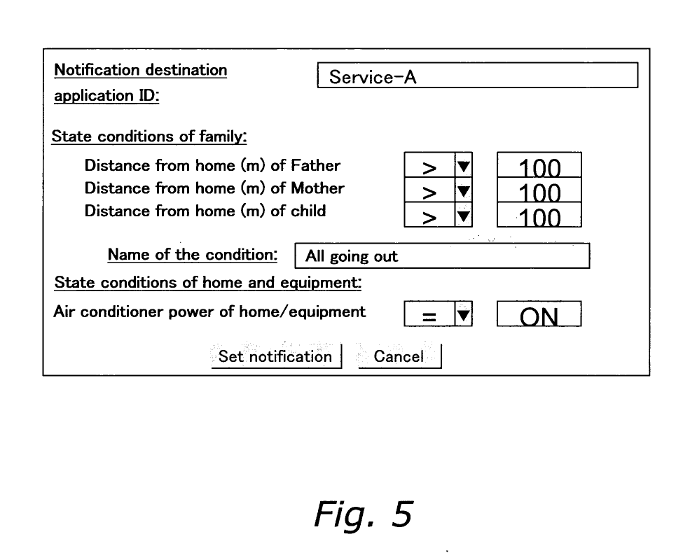

FIG. 5 is an illustrative diagram showing an exemplary setting screen for composite notification conditions. The composite notification condition receiving unit 12 can provide a setting screen for composite notification conditions to the service application terminals 3. The setting screen receives settings of conditions for state values of selected state information and settings of the ways for binding the conditions. In this example, “distance from home (m)” for each of the father, mother, and child is respectively set to be larger than 100, and the state of equipment, “air conditioner power”, is set to be ON. It is set that the conditions are all bound by logical multiplication. Further, the setting screen can receive setting of state names of the composite states. In this example, “all going out” is set as the state name. The setting screen can also receive setting of the notification destination service applications of the composite states. In this example, “Service-A” is set as the notification destination.

Further, the composite notification condition receiving unit 12 can determine whether or not a part or all of the composite notifying condition which is set matches the composite notification condition which has already been stored with making reference to the composite notification condition management table 112. The determination can be made using a known determination method which allows for a certain level of vagueness.

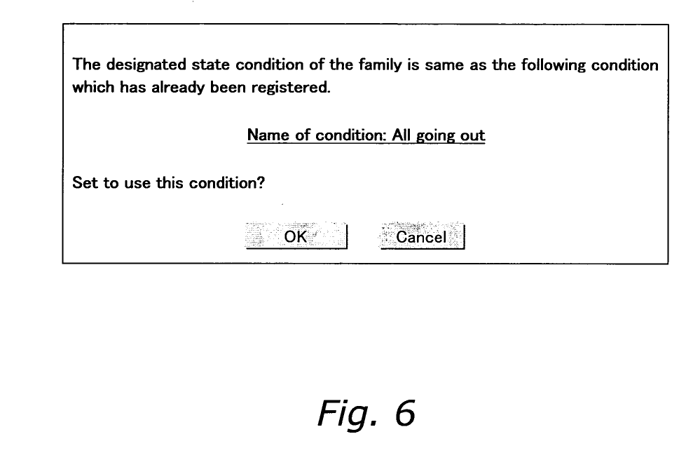

FIG. 6 shows an exemplary confirmation screen for confirming overlap determination. When a determination method which allows for a certain level of vagueness in determining overlap of composite notification conditions is used, the composite notification condition receiving unit 12 preferably presents a confirmation screen to the service application terminal 3. The confirmation screen makes inquiry to the developers of the service applications whether or not to use overlapping composite notification conditions. This is because, even when the composite notification conditions are determined to be the same in overlap determination, they may different for the developers of the applications.

If OK is selected on the confirmation screen, the composite notification condition receiving unit 12 allocates a state information ID to overlapping composite notification conditions. The composite notification condition receiving unit 12 makes a new entry for a composite state defined by the composite notification conditions to which the state information ID is allocated to the state information management table 111, and registers the state information. The value of the “state name” included in the state information can be obtained from the setting screen. Further, the value of the “state type” is fixed to “family” in this example. The state information specified by the state information ID “D001” in the state information management table 111 shown in FIG. 3 is the state information of the composite state registered in this way.

Then, for an overlapping portion of the newly set composite notification condition, the composite notification condition receiving unit 12 registers a description of the composite notification condition using the state information ID to the composite notification condition management table 112. For example, it is assumed that the setting as shown in FIG. 5 is input where the composite notification condition “A003>100 and B003>100 and C003>100” has already been registered as the composite notification condition in the composite notification condition management table 112 as shown in FIG. 3. In such a case, the composite notification condition “A003>100 and B003>100 and C003>100” overlaps with the composite notification condition which has already been registered. Thus, state information ID “D001” is allocated to the composite notification condition “A003>100 and B003>100 and C003>100” which has already been registered. Then, the new composite notification condition is described as “D001=TRUE and Y001=TRUE” using the state information ID “D001”.

When a part of the stored composite notification condition overlaps with the newly set composite notification condition, it is preferable that the composite notification condition receiving unit 12 allocates a state information ID to an overlapping portion, and then, re-describe the stored composite notification condition using the state information ID.

As described above, overlapping descriptions for overlapping composite notification conditions are avoided. Thus, the state management apparatus 1 no longer have to repeat making the same determinations. In this way, a burden of determination on the state management apparatus 1 can be alleviated.

(3-2) Update and Notification of Composite States

When the state information management table 111 is updated due to update of a state value of any of the states, the composite notification condition determining unit 13 determines whether or not to update the composite states. More specifically, the composite notification condition determining unit 13 searches for composite notification conditions including the state information ID of the updated state information from the composite notification condition management table 112. Further, the composite notification condition determining unit 13 determines state values of the composite states defined by the composite notification conditions hit in the search. Among the determined state values, state values of the composite states to which the state information IDs are allocated are registered to the state information management table 111. Further, among the determined state values, state values of the composite states for which the notification destination service application IDs being are set are notified to the service applications by the state information notifying unit 15.

Such notification may be performed by message transmission to the service application terminals 3 by using, for example, Simple Object Access Protocol (SOAP).

(3-3) Management of State Information

The state information update receiving unit 14 receives updates of state information other than those for composite states, i.e., state information for individual objects, and updates the state information management table 111. The state information update receiving unit 14 also receives requests for updating state values of the composite states to which the state information IDs are allocated from the composite notification condition determining unit 13, and updates the state information management table 111.

Process Flow

(1) State Management Apparatus

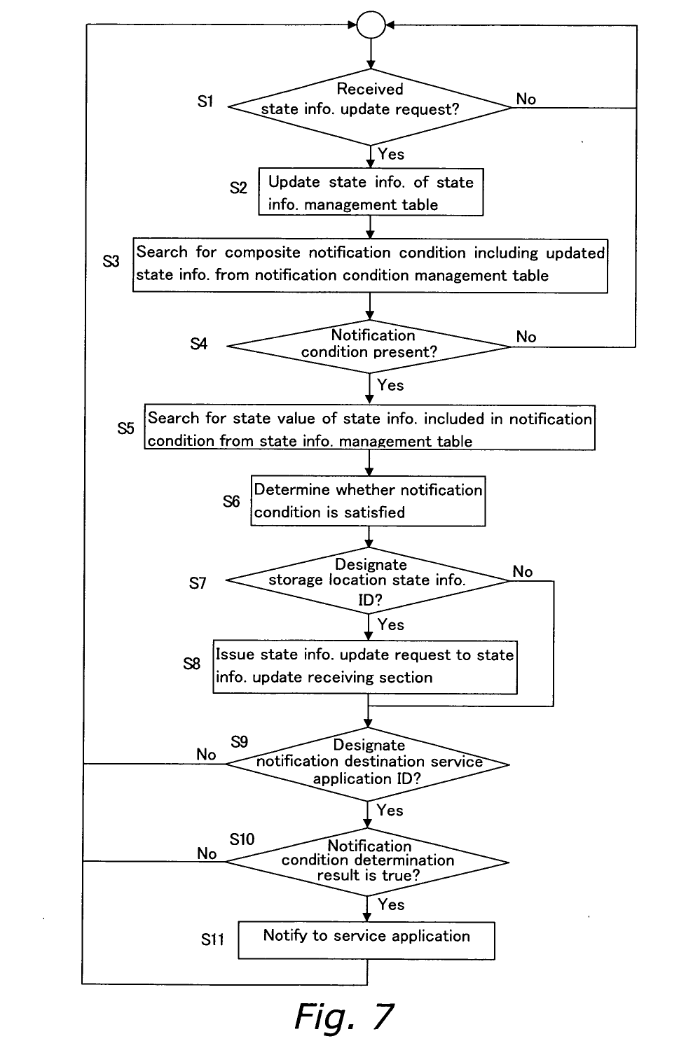

FIG. 7 is a flow diagram showing an exemplary flow of a state management process performed by the state management apparatus 1.

Step S1: The state information update receiving unit 14 waits for a notification of new state information, i.e., state information update request from any of the state update apparatuses 2. When the state information update receiving unit 14 receives the request, the process moves to step S2.

Step S2: The state information update receiving unit 14 updates the state information management table 111 based on the received state information update request.

Steps S3 and S4: The composite notification condition determining unit 13 searches for composite notification conditions including the updated state information from the composite notification condition management table 112 (step S3). When such a composite notification condition exists, the process moves to step S5 (step S4). When such a composite notification condition does not exist, the process returns to step S1 where the state information update receiving unit 14 waits for a state information update request.

Step S5: The composite notification condition determining unit 13 obtains the state values of the state information included in the composite notification conditions hit in step S4 from the state information management table 111.

Step S6: The composite notification condition determining unit 13 determines whether a composite notification condition is satisfied or not for each of the composite notification conditions hit in step S4 based on the obtained state information. In other words, the composite notification condition determining unit 13 makes determinations on the state values of the composite states represented by the composite notification conditions. The result of the determination is represented by either a value “TRUE” or “FALSE”, and is passed to a determination result registering unit.

Steps S7 and S8: The composite notification condition determining unit 13 determines whether or not a storage location state information ID is designated for each of the composite notification conditions determined at step S6 (step S7). IF a storage location state information ID is designated, the state value of the state information specified by the state information ID is overwritten with the value determined at step S6 (step S8). Specifically, the composite notification condition determining unit 13 passes the state information ID and the state value to the state information update receiving unit 14, and issues a state information update request to overwrite the state value. If a storage location state information ID is not designated for the composite notification condition (step S7), the process moves to step S9.

Steps S9 through S11: The composite notification condition determining unit 13 determines whether or not a notification destination service application ID is designated for each of the composite notification conditions hit in step S4. If a notification destination service application ID is designated, the composite notification condition determining unit 13 further determines whether the composite notification condition is satisfied or not (step S10). If a composite notification condition is satisfied, the composite notification condition determining unit 13 notifies to the designated service application that the composite notification condition is satisfied (step S11). If a notification destination service application ID is not designated for each of the composite notification conditions hit at step S4 or the composite notification condition thereof is not satisfied, the process returns to step S1 and repeats the above-described process.

With the above-described process, it becomes possible for the state management apparatus 1 to manage the composite states where a plurality of state information are combined. As a result, service such as providing another information, controlling equipment, and the like can be provided in response to changes in state values of the composite states. Moreover, since an overlapping portion of determination is not repeated in determination on the composite states in the state management apparatus 1, a burden on the state management apparatus 1 can be alleviated. The state information managed by the state management apparatus 1 can be combined without constraints to generate composition states, and the state values thereof can be utilized. Thus, it becomes possible to manage state information in a flexible manner and to provide new services by utilizing such management.

(2) State Update Apparatus

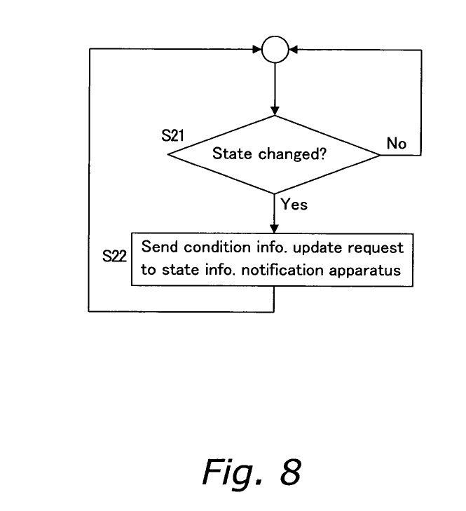

FIG. 8 is a flow diagram showing an exemplary flow of a process performed by the state update apparatus 2. The state update apparatus 2 monitors changes in user states (step S21). When a user state changes, the state update apparatus 2 sends new state information to the state management apparatus 1 (state information update request) (step S22).

(3) Service Application Terminal

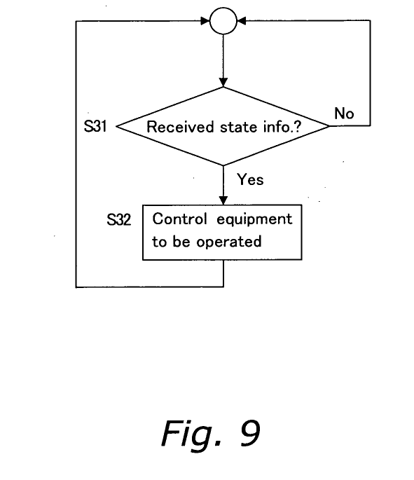

FIG. 9 is a flow diagram showing an exemplary flow of a process performed by the service application terminal 3. The service application terminal 3 waits for a notification of state information from the state management apparatus 1 (step S31). When the service application terminal 3 receives the notification, it performs a process based on the state information. For example, a service application for controlling an air conditioner controls the air conditioner to switch off the power when it receives a state value “TRUE” of the state information from the state management apparatus 1.

According to the present invention, the state management apparatus 1 makes determination based on a plurality of state information. Thus, the service applications can be simplified. This allows a flexible and complex management of state information, such as, generating various state information by combining state information, updating the generated state information, and the like.

Further, a determination logic related to state information can be shared by a plurality of service applications. This allows facilitating the development of service applications.

Since new composite conditions are generated based on state values of the composite states, the state management apparatus 1 can be prevented from repeatedly making the same determination. Thus, the efficiency of the determination logic of the state management apparatus 1 can be improved.

Embodiment 2

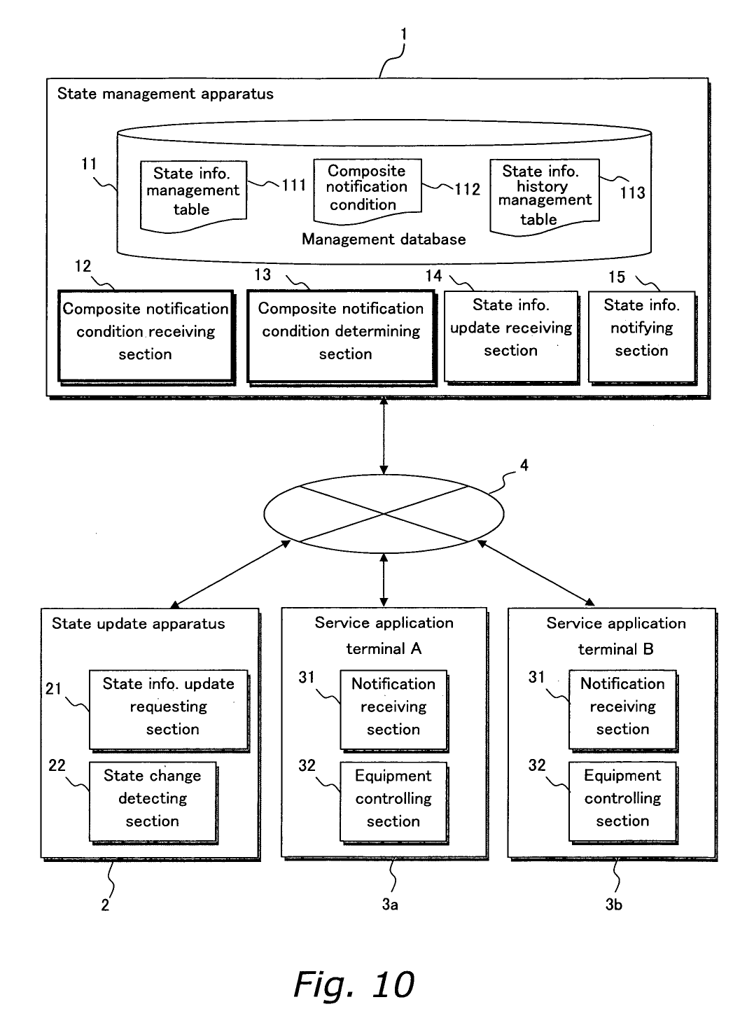

FIG. 10 is a schematic block diagram of a state management system according to Embodiment 2. This state management system has the structure same as that of the state management system according to Embodiment 1 except for the point that it further includes a state information history management table 113. In Embodiment 2, the determination process for the composite notification conditions by the state management apparatus 1 can be performed more rapidly.

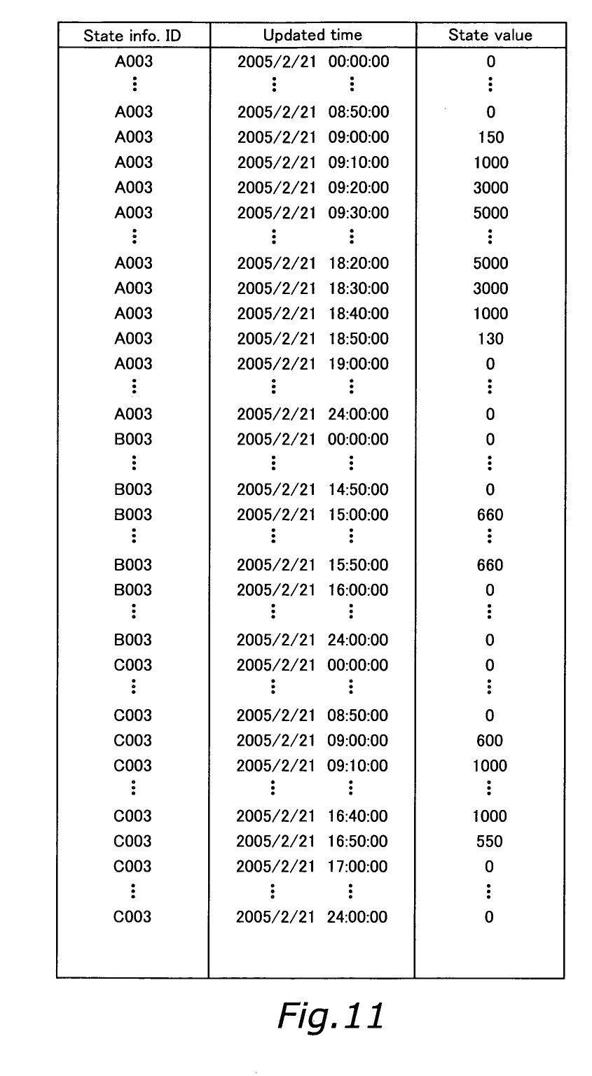

FIG. 11 is a conceptual diagram illustrating the state information history management table 113. The state information history management table 113 stores history information which is update history for each of the state values. In this example, history information of one day in the case where the state information are updated in every 10 minutes is recorded in the state information history management table 113. Alternatively, a new state value may be recorded to the state information history management table 113 every time the state information changes. Or rather, a new state value may be recorded to the state information history management table 113 every time a variation width of the state value exceeds a predetermined value. A time interval for resetting the update history, i.e., history recording time is not limited to one day, 24 hours. The state information update receiving unit 14 writes the history information to the state information history management table 113, and rest the state information history management table 113.

As shown in FIG. 11, the history information includes “state information ID”, “update time” of the state value, and updated “state value” in one record. In this example, the history information related to state values of state name “distance from home (m)” among various state values for the respective state types. However, the state information history management table 113 may store the state values of other state names.

In this embodiment, the composite notification condition receiving unit 12 rearrange conditions which form a newly set composite notification condition in order of probabilities that the conditions are satisfied. Thus, the composite notification condition determining unit 13 can detect that the composite notification condition is not satisfied more rapidly. The probability that each of the conditions is satisfied is calculated based on the state information history management table 113.

For clarification, the composite notification condition management table 112 shown in FIG. 3 is used for description. The composite notification condition “A003>100 and B003>100 and C003>100” shown in FIG. 3 is formed by binding three conditions by logical multiplication. If these three conditions are determined in ascending order of probabilities that the conditions are satisfied, it can be detected that the composite notification condition is not satisfied more rapidly. The probabilities that the conditions are satisfied are obtained as follows.

First, the composite notification condition receiving unit 12 calculates a length of time during which each of the conditional expressions which form the composite notification condition is satisfied and a length of time during which it is not satisfied based on changes in each of the state values. As shown in FIG. 11, lengths of time during which “A003>100”, “B003>100”, and “C003>100” are respectively satisfied and not satisfied can be obtained as follows.
Father: 9 hours from 00:00:00 to 09:00:00, Feb. 21, 2005: not satisfied,
   10 hours from 09:00:00 to 19:00:00, Feb. 21, 2005: satisfied,
   5 hours from 19:00:00 to 24:00:00, Feb. 21, 2005: not satisfied,
Mother: 15 hours from 00:00:00 to 15:00:00, Feb. 21, 2005: not satisfied,
   1 hour from 15:00:00 to 16:00:00, Feb. 21, 2005: satisfied,
   8 hours from 16:00:00 to 24:00:00, Feb. 21, 2005: satisfied,
Child: 9 hours from 00:00:00 to 09:00:00, Feb. 21, 2005: not satisfied,
   8 hours from 09:00:00 to 17:00:00, Feb. 21, 2005: satisfied,
   7 hours from 17:00:00 to 24:00:00, Feb. 21, 2005: not satisfied.

Next, the composite notification condition determining unit 13 calculates the probabilities that the conditional expressions which form the composite notification condition are satisfied. For example, probability F that the “distance from home (m)” of the father exceeds 100 m is calculated as follows.
Probability F=(total time during which conditional expression “A003>100” is satisfied)×100 (%)/(history recording time)
=10 (hours)/24 (hours)
=41.67%

Similarly, probabilities M and C that “distance from home (m)” of the mother and child exceed 100 m are calculated as follows.
Probability M=(total time during which conditional expression “B003>100” is satisfied)×100 (%)/(history recording time)
=1 (hour)/24 (hours)
=4.17%
Probability C=(total time during which conditional expression “C003>100” is satisfied)×100 (%)/(history recording time)
=8 (hours)/24 (hours)
=33.3%

Based on the probabilities calculated as such, the composite notification condition receiving unit 12 optimizes the composite notification condition so that the conditions are determined in ascending order of probabilities that the conditions are satisfied. As a result, the composite notification condition “A003>100 and B003>100 and C003>100” shown in FIG. 3 is updated to “B003>100 and C003>100 and A003>100”.

The above example shows the case of the composite notification condition which includes a plurality of conditional expressions bound by logical multiplication. In the case of a composite notification condition which includes a plurality of conditional expressions bound by logical additions, the composite notification condition determining unit 13 rearrange the composite notification condition in descending order of the probabilities that the conditional expressions are satisfied. For example, the composite notification condition “D001=TRUE and Y001=TRUE” shown in FIG. 3 is formed by binding conditional expressions “D001=TRUE” and “Y001=TRUE” by logical addition. When such a composite notification condition is set, the composite notification condition determining unit 13 calculates the probability that the conditional expressions are satisfied, and rearranges the conditional expressions in descending order of probabilities that the conditional expressions are satisfied. In this way, it becomes possible to detect that the composite notification condition is satisfied more rapidly.

Probability D that the conditional expression “D001=TRUE” is satisfied is calculated based on lengths of time during which the composite notification condition corresponding to state information ID “D001” of the composite state is satisfied and is not satisfied. According to the state information history management table 113 shown in FIG. 11, the values are as follows.
“D001”: 15 hours from 00:00:00 to 15:00:00, Feb. 21, 2005: FALSE,
   1 hour from 15:00:00 to 16:00:00, Feb. 21, 2005: TRUE,
   8 hours from 16:00:00 to 24:00:00, Feb. 21, 2005: FALSE
      Probability D=(total time during which conditional expression “A003>100 and B003>100 and C003>100” is satisfied)×100 (%)/(history recording time)
      =1 (hour)/24 (hours)
      =4.17%

Even when both logical multiplication and logical addition are included in the composite notification condition, the order of describing the conditional expressions can be optimized by combining the above described ways of thinking.

As described above, optimizing the order of the conditional expressions which form the composite notification conditions can reduce a time period required for determination of the composite notification conditions, and alleviate a burden and a process on and by a CPU of the state management apparatus 1.

Other Embodiments

(A) In the above examples, the present invention is applied to the home network 4. However, the present invention is not limited to this. For example, the present invention can be applied to in-vehicle machines, portable terminals, robots and the like. When the state management system of the present invention is mounted to a vehicle, for example, services, such as issuing a speed alarm based on a traveling speed of the vehicle, and slipperiness of a road surface, can be provided.

When the state management system of the present invention is applied to portable terminals, such as a GPS-equipped mobile phones, PDAs, and the like, for example, services, such as distributing information on delay of trains based on the distance from the current position to the nearest station, and delay information of trains, can be provided.

When the state management system of the present invention is applied to robots, services of autonomous control robots based on information from various sensors attached to robots can be provided.

(B) A computer program which causes a computer to execute the above-described methods and a computer-readable recording medium having such a program recorded thereon are within the scope of the present invention. The computer readable recording medium may be, for example, a flexible disc, hard disc, CD-ROM, MO, DVD, DVD-ROM, DVD-RAM, Blue-ray Disc (BD), semiconductor memory, and the like.

The computer program is not limited to that recorded on the recording medium, but may be transmitted via telecommunication lines, wireless or wire communication lines, networks such as Internet, or the like.

The present invention can be applied to a system for managing state information, and can diversify management and available state information.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. A state management apparatus for managing the states of a plurality of objects, comprising:
a state storing unit that associates the plurality of objects with state information for the plurality of objects and stores the same;
an updating unit that receives an update request for state information for any object and updates the state information for that object based on the update request;
a condition storing unit that stores a composite notification condition based on a plurality of state information; and
a determining unit that determines whether a composite notification condition based on the updated state information is satisfied or not in response to the update of the state information by the updating unit.

2. A state management apparatus according to claim 1, further comprising a selection screen generating unit that displays a portion or all of the state information stored in the state storing unit, and generates a selection screen which receives a selection of a plurality of state information.

3. A state management apparatus according to claim 2, wherein the selection screen generating unit generates a selection screen which displays the state information grouped according to the objects.

4. A state management apparatus according to claim 3, wherein the selection screen generating unit generates a selection screen which displays the state information in a tree structure for each of the objects.

5. A state management apparatus according to claim 2, further comprising:
a setting screen generating unit that generates a setting screen which receives one or more settings for a composite notification condition based on a plurality of state information for which the selection is received at the selection screen generating unit, wherein
the condition storing unit further stores the composite notification condition received by the setting screen generating unit.

6. A state management apparatus according to claim 5, further comprising:
an overlap determining unit that determines whether or not the composite notification condition received by the setting screen generating unit overlaps with the composite notification condition stored in the condition storing unit, wherein
the state storing unit further stores the state information of a composite state defined by the overlapping composite notification conditions, and
the condition storing unit stores the composite notification condition received by the setting screen generating unit as the composite notification condition based on the state information of the composite state defined by the overlapping composite notification conditions.

7. A state management apparatus according to claim 6, wherein the overlap determining unit generates a confirmation screen for confirming the result of the determination.

8. A state management apparatus according to claim 6, wherein the state storing unit stores, as a portion of the state information of the composite state, the result of the determination by the determination unit regarding the composite notification condition which defines the composite state.

9. A state management apparatus according to claim 5, wherein:
the state storing unit further stores update history of the state information;
the composite notification condition is described using logical multiplication and/or logical addition of the conditions for a plurality of state information;
the condition storing unit describes the conditions in descending order of probabilities that the conditions which form the composite notification condition are satisfied for logical multiplication, and in ascending order for logical addition based on the update history of the state information.

10. A state management program executed on a computer terminal which manages the states of a plurality of objects, the state management program causing the computer terminal to function as:
a state storing unit that associates the objects with state information for the objects and stores the same;
an updating unit that receives an update request for state information for any object and updates the state information for that object based on the update request;
a condition storing unit that stores a composite notification condition based on a plurality of state information; and
a determining unit that determines whether a composite notification condition based on the updated state information is satisfied or not in response to the update of the state information by the updating unit.

11. A computer readable recording medium having recorded thereon a state management program that manages the states of a plurality of objects, the state management program causing a computer to execute the steps of:
associating the objects with state information for the objects and storing the same;
receiving an update request for state information for any object and updating the state information for that object based on the update request;
storing a composite notification condition based on a plurality of state information; and
determining whether a composite notification condition based on the updated state information is satisfied or not in response to the update of the state information at the receiving step.

12. A state management method for managing states of a plurality of objects, comprising the steps of:
associating the objects with state information for the objects and storing the same;
receiving an update request for state information for any object and updating the state information of that object based on the update request;
storing a composite notification condition based on a plurality of state information; and
determining whether a composite notification condition based on the updated state information is satisfied or not in response to the update of the state information at the receiving step.
